(19) United States
(12) Patent Application Publication
(10) Pub. No.: US 2014/0083632 A1
(43) Pub. Date: Mar. 27, 2014

(54) Door Curtain Apparatus for Automobile Having Drooping Prevention Function

(71) Applicant: HYUNDAI MOTOR COMPANY, Seoul (KR)

(72) Inventor: Wan-Su Park, Gurye-eup (KR)

(73) Assignee: Hyundai Motor Company, Seoul (KR)

(21) Appl. No.: 13/707,457

(22) Filed: Dec. 6, 2012

(30) Foreign Application Priority Data
Sep. 27, 2012 (KR) 10-2012-0107784

(51) Int. Cl. B60J 1/20

(52) U.S. Cl. CPC B60J 1/2011
USPC 160/323.1

(57) ABSTRACT

A door curtain apparatus for an automobile includes a suspending rod for winding a door curtain, a shaft installed inside the suspending rod so as to penetrate both ends of the suspending rod, a fixture into which one end of the shaft is inserted, a link member which is coupled to the other end of the shaft, and an adjustment spindle coupled to the link member so as to move the link member up and down.

### CROSS-REFERENCE TO RELATED APPLICATIONS

The present application claims priority of Korean Patent Application Number 10-2012-107784 filed Sep. 27, 2012, the entire contents of which application is incorporated herein for all purposes by this reference.

### BACKGROUND OF INVENTION

1. Field of Invention

The present invention relates to a door curtain apparatus which is mounted in an automobile, and more particularly to a door curtain apparatus for an automobile, which is provided with a suspending rod for winding a door curtain, a shaft installed inside the suspending rod so as to penetrate both ends of the suspending rod, a fixture into which one end of the shaft is inserted, a link member which is coupled to the other end of the shaft, and an adjustment spindle coupled to the link member so as to move the link member up and down.

2. Description of Related Art

In general, a door curtain apparatus is installed on a side door or a rear door of an automobile so as to block sunlight and prevent an interior space from being exposed to an exterior.

FIG. 1 shows a general door curtain apparatus. In order to mount a door curtain for covering an area from a lower end of a window frame of an automobile to an upper end of the window frame, a suspending rod 2 on which the door curtain (not illustrated) is suspended and wound is installed so as to be fixed to an upper portion of an inner panel of a door by both flanges 3 and 3′, and a frame 1 formed with a suspending groove 6 for fixing a hook (not illustrated) provided at an end of the door curtain which is spread out from the suspending rod 2 is installed on the upper end of the window frame by means of a fixing member 4.

However, in the door curtain apparatus as described above, because a line shape of the end of the door curtain which is spread out is not identical to a shape of a dispersed line l of the frame 1, which is formed in a curved arch shape, a curtain surface droops in a direction toward the interior of the automobile when the door curtain is suspended on the frame 1.

Accordingly, the problem of the door curtain drooping results in a deterioration of the effects of blocking sunlight and shielding the interior of the automobile, which are the original functions of the door curtain for an automobile.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a configuration of a door curtain apparatus for an automobile, which may prevent a curtain surface from drooping in a state in which the door curtain apparatus is spread out.

Various aspects of the present invention provide for a door curtain apparatus for an automobile having a drooping prevention function, including: a suspending rod for winding a door curtain; a shaft installed inside the suspending rod so as to penetrate both ends of the suspending rod; a fixture into which one end of the shaft is inserted; a link member coupled to the other end of the shaft; and an adjustment spindle coupled to the link member so as to move the link member up and down.

The door curtain apparatus for an automobile having a drooping prevention function may adjust an angle and a position of the suspending rod, using a shaft mounted inside the suspending rod for winding the door curtain, so that the door curtain may be tightly spread out without causing drooping, thereby improving a sunlight blocking performance and a shielding performance of the door curtain.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a configuration view of a general door curtain apparatus.

FIG. 2 is a configuration view of an exemplary door curtain apparatus according to the present invention.

FIG. 3 is an operational state view illustrating an adjustment to shorten or lengthen a length of an exemplary shaft according to the present invention.

FIG. 4 is an operational state view illustrating an adjustment of a vertical position of an exemplary suspending rod according to the present invention.

FIG. 5 is a cross-sectional view illustrating an exemplary configuration of a fixture according to the present invention.

FIGS. 6 and 7 are operational state views illustrating operations of fixing the droop of the door curtain of an exemplary door curtain apparatus according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Further, unless terms used in the present specification are defined, they have meanings commonly understood by those skilled in the art to which the present invention pertains and known functions and configurations which may unnecessarily obscure the gist of the present invention will not be described in detail in the following description and accompanying drawings.

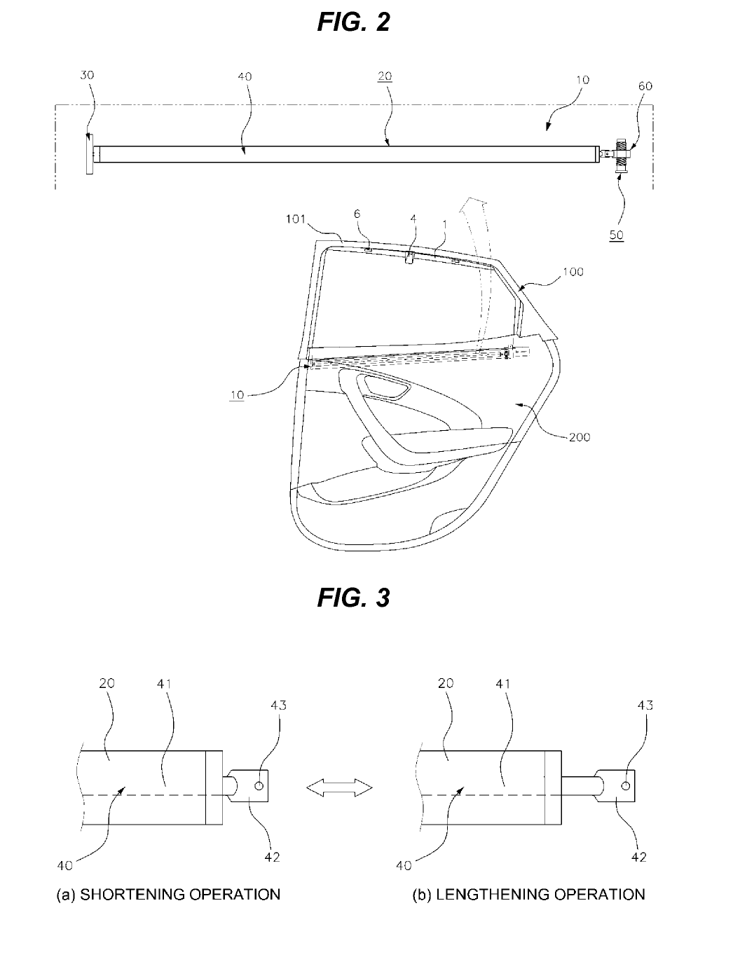

FIG. 2 is a configuration view of a door curtain apparatus for an automobile according to the present invention. As shown, a door curtain apparatus 10 of the present invention is installed on a lower end of a window frame 100 which is formed on an upper portion of a door inner panel 200 of an automobile.

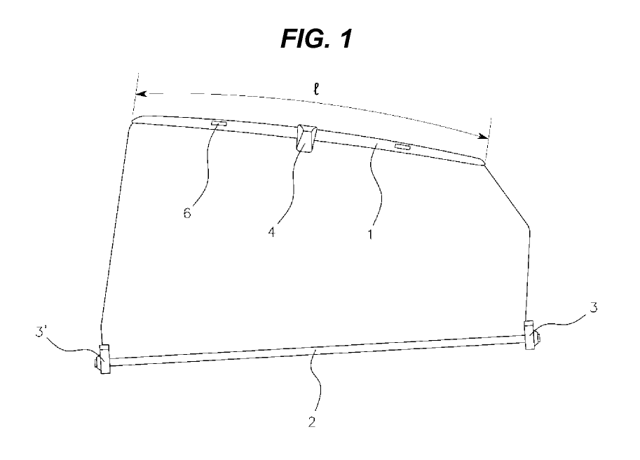

As described above with reference to FIG. 1, a frame 1 is mounted on an upper portion 101 of the window frame 100 by means of a fixing member 4, and a suspending groove 4 is formed in the frame 1 to fix a hook (not illustrated) formed on an end of a door curtain.

The door curtain apparatus 10 of the present invention is suspended by using the frame 1 and includes a suspending rod 20, a shaft 40, a fixture 30, a link member 60, and a spindle 50. A more detailed description is provided below.

The suspending rod 20 has a cylindrical bar shape. A door curtain (not illustrated) is suspended on the suspending rod 20 and is wound around the suspending rod 20.

The shaft 40 penetrates both ends of the suspending rod 20 so as to be installed inside the suspending rod 20.

Here, one end of the shaft 40 is inserted onto the fixture 30, and the other end of the shaft 40 is coupled to the link member 60.

The link member 60 is coupled to the spindle 50. The link member 60 coupled to the spindle 50 is movable up and down on the spindle 50.

FIG. 3 is a detailed view of the shaft 40. The shaft 40 has a bar-shaped body 41, which is longitudinally extended. A flat-plate-shaped head 42 is formed at one end of the body 41 so as to be coupled to the link member 60. A hinge hole 43 into which a hinge protrusion 63 of an arm 62 formed on a nut 61 of the link member 60, which will be described below, is inserted is formed in the head 42 by perforation.

Therefore, as shown in FIG. 3, when the head 42 of the shaft 40 pivots forward or backward, a length of the head 42 protruding from the suspending rod 20 can be shortened or lengthened. This may be accomplished because the other end of the shaft 40 inserted into the fixture 30 has a clearance with a predetermined distance from the inside of the fixture 30, as shown in FIG. 5.

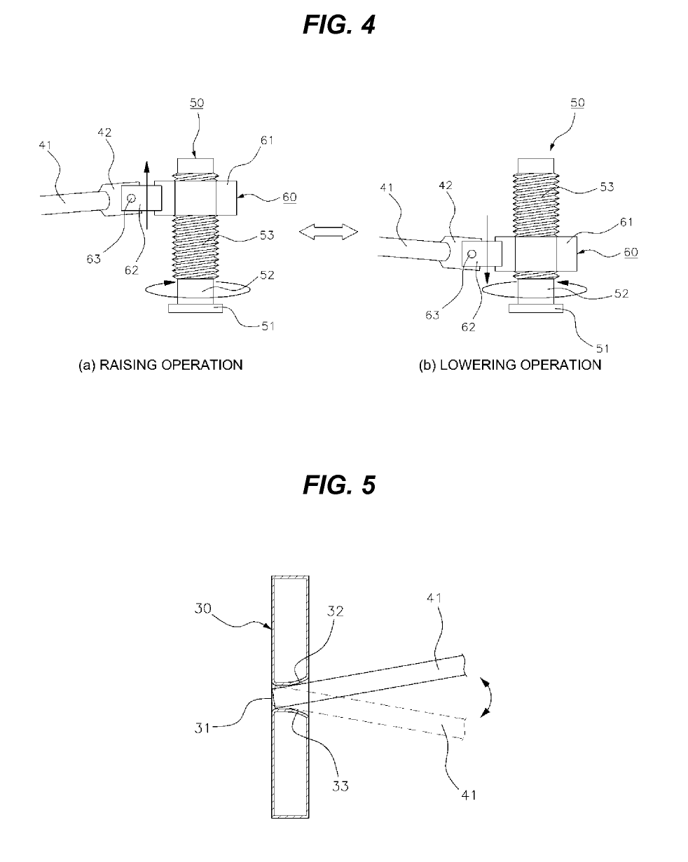

FIG. 4 is a detailed view of the spindle 50 and the link member 60.

The spindle 50 is a member which is installed on the door inner panel 200. The spindle 50 has a body 52 vertically protruding from a base 51, and threads 53 are formed on the body 52.

The link member 60 includes the nut 61 formed with inner threads (not illustrated) which is engaged with the threads 53 formed on the body 52, and the arm 62 formed on one side of the nut 61 and having the hinge protrusion 63 which is inserted into the hinge hole 43 formed in the head 42 of the shaft 40.

Since the link member 60 is threadedly engaged with the body 52 of the spindle 50, the position of the nut 61 may be raised on the spindle 50 by rotating clockwise the base 51 of the spindle 50, as shown in FIG. 4. On the other hand, the position of the nut 61 may be lowered on the spindle 50 by rotating counterclockwise the base 51.

Therefore, as the nut 61 is raised or lowered, the vertical positions of the shaft 40 connected to the nut 61 and the whole suspending rod 20 in which the shaft 40 is installed may be raised or lowered.

FIG. 5 shows a cross section of the fixture 30 of the present invention. The fixture 30 has a cylindrical shape. A through hole 31 to which the other end of the body 41 of the shaft 40 is inserted and fixed is formed at a center of the fixture 30. An upper portion and a lower portion of an inner wall surface of the through hole 31 are respectively formed as an upper inclined surface 32 and a lower inclined surface 33, which are inclined upward, so that an opening of the through hole 31 may be enlarged.

Therefore, as shown in FIG. 5, the shaft 40 inserted into the fixture 30 through the opening of the through hole 31 may pivot upward and downward in a predetermined angle range in the through hole 31.

Hereinafter, operations of the door curtain apparatus 10 of the present invention, which is configured as described above, will be described in detail.

The door curtain apparatus 10 of the present invention, which is configured as described above, performs operations of adjusting a protruding length of the head 42 of the shaft 40 from the suspending rod 20 forward or backward by pivoting the head 42 forward or backward, raising or lowering the position of the nut 61 on the spindle 50 by rotating the base 51 of the spindle 50, and pivoting the shaft 40, which is inserted into the fixture 30 through the opening of the through hole 31, upward or downward in a predetermined angle range in the through hole 31.

Therefore, in the door curtain apparatus 10 of the present invention, an angle and a position of the suspending rod 20 may be adjusted by the above-described operations, so that the door curtain may be spread out in a tight state without causing drooping.

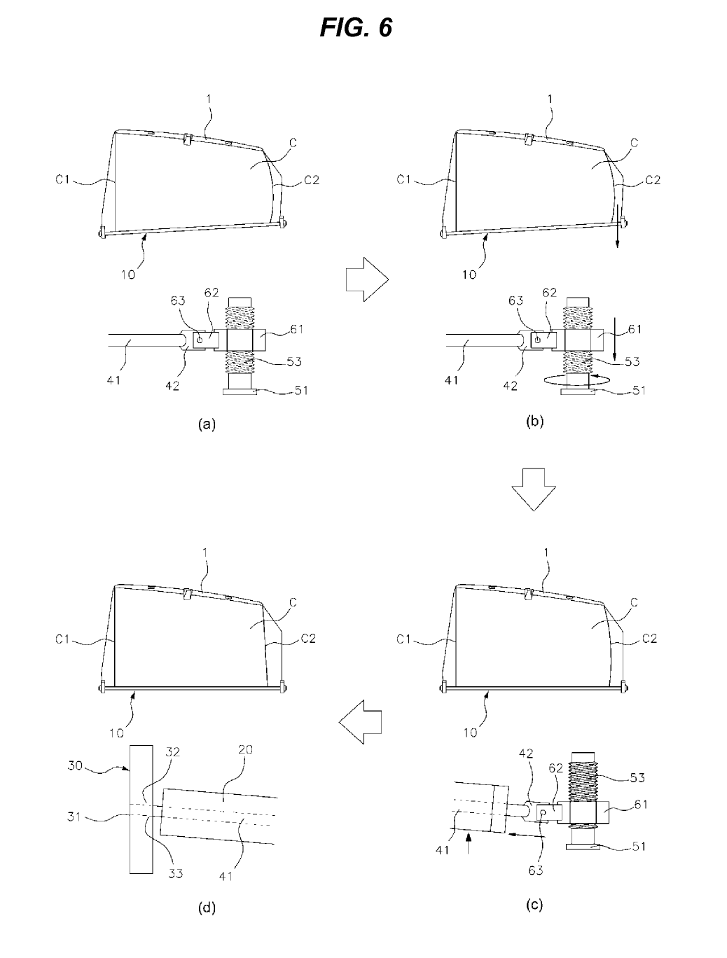

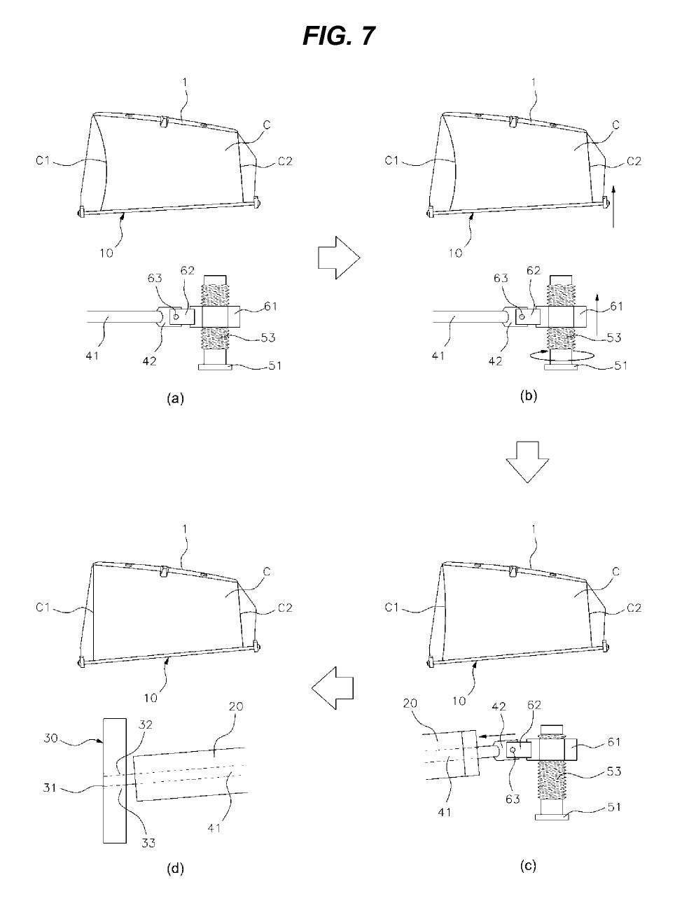

Referring to FIGS. 6 and 7, which are views illustrating operational states, a detailed description is provided below.

FIG. 6(a) shows a state in which a rear end portion (C2) of a curtain (C) droops, when the door curtain (C) is spread out and suspended on the frame 1, by applying the door curtain apparatus of the present invention.

The drooping rear end portion (C2) of the curtain in the above described state of FIG. 6(a) should be spread out. Therefore, when the nut 61 coupled to the body 52 is lowered by rotating the adjustment spindle 50 counterclockwise, as shown in FIG. 6(b), the body 41 of the shaft 40 having the head (42) hingedly coupled to the nut 61 is lowered along with the nut 61, and thus the whole suspending rod 20 having the shaft 40 is moved downward so that the drooping rear end portion (C2) of the curtain becomes gradually tight when spread out.

Next, in order for the curtain C to be spread out more tightly, the body 41 of the shaft 40 is lifted upward based on the hinge protrusion 63 of the arm 62 of the nut 61, and at the same time, the suspending rod 20 is moved back a little toward the fixture 30, as shown in FIG. 6(c). Therefore, as a gradient of the suspending rod 20 is minutely adjusted, the rear end portion C2 of the curtain is spread out more evenly than the rear end portion C2 in the state of FIG. 6(b), and thus the rear end portion C2 of the curtain is tightly spread out, as shown in FIG. 6(d).

On the other hand, unlike the above described state of FIG. 6, FIG. 7(a) shows a state in which a front end portion C1 of a curtain C droops, when the door curtain (C) is spread out and suspended on the frame 1, by applying the door curtain apparatus of the present invention.

The drooping front end portion (C1) of the curtain in the state of FIG. 7(a) should be spread out. Therefore, when the nut 61 coupled to the body 52 is raised by rotating the spindle 50 clockwise, as shown in FIG. 7(b), the body 41 of the shaft 40 having the head (42) hingedly coupled to the nut 61 is raised along with the nut 61, and thus the whole suspending rod 20 having the shaft 40 is moved upward so that the drooping front end portion (C1) of the curtain becomes gradually tight when spread out.

Next, in order for the curtain C to be spread out more tightly, the body 41 of the shaft 40 is lowered downward based on the hinge protrusion 63 of the arm 62 of the nut 61, and at the same time, the suspending rod 20 is moved back a little toward the fixture 30, as shown in FIG. 7(c). Therefore, as a gradient of the suspending rod 20 is minutely adjusted, the front end portion C1 of the curtain is spread out more evenly than the front end portion C1 in the state of FIG. 7(b), and thus the back end portion C2 of the curtain is tightly spread out, as shown in FIG. 7(d).

Accordingly, the drooping of the front end portion C1 or the rear end portion C2 of the door curtain can be prevented by the above described operations of the door curtain apparatus 10 of the present invention.

For convenience in explanation and accurate definition in the appended claims, the terms upper or lower, front or rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A door curtain apparatus for an automobile, comprising:
a suspending rod on which a door curtain is wound;
a shaft installed inside the suspending rod so as to penetrate opposing ends of the suspending rod;
a link member coupled to an end of the shaft; and
a spindle to which the link member is coupled movably upward and downward.

2. The apparatus of claim 1, wherein one end of the shaft is inserted into a fixture.

3. The apparatus of claim 1, wherein the shaft comprises a body, and a head which is formed on one end of the body and has a hinge hole formed by perforation.

4. The apparatus of claim 3, wherein the link member comprises a nut formed with inner threads, and an arm which is formed on one side of the nut and has a hinge protrusion which is inserted into the hinge hole.

5. The apparatus of claim 4, wherein the spindle has a body vertically protruding from a base installed on a door inner panel, threads are formed on the body, and the nut of the link member is engaged with the threads of the body.

6. The apparatus of claim 2, wherein a through hole into which the other end of the body of the shaft is inserted is formed at a center of the fixture, and an inner wall surface of the through hole has an upper inclined surface and a lower inclined surface.
